(19) United States
(12) Patent Application Publication
(10) Pub. No.: US 2026/0013471 A1
(43) Pub. Date: Jan. 15, 2026

(54) Rawhide-Free Highly Digestible Dog Chew

(71) Applicant: GlobalOne Pet, Inc., Aliso Viejo, CA (US)

(72) Inventors: Brett Weinberg, San Clemente, CA (US); Michael Farmer, Southlake, TX (US)

(21) Appl. No.: 19/281,307

(22) Filed: Jul. 25, 2025

Related U.S. Application Data
(63) Continuation-in-part of application No. 17/918,305, filed on Oct. 11, 2022, now abandoned.
(60) Provisional application No. 63/013,533, filed on Apr. 21, 2020.

(51) Int. Cl. A01K 15/02; A23K 10/30; A23K 30/20; A23K 40/25; A23K 50/40

(52) U.S. Cl. CPC A01K 15/026; A23K 10/30; A23K 30/20; A23K 40/25; A23K 50/40

(57) ABSTRACT

A dog chew is described made from plant-based ingredients (excluding the common allergens corn, wheat, soy and gluten), binding agents (such as bone-based gelatins), humectants and preservatives, then coated with a flavoring material (such as poultry, meat or fish and other flavorings), and being entirely free from commonly used poorly digestible ingredients (such as rawhide, reconstituted rawhide, synthetic materials and gums). A preferred formula and method for producing a hide-free dog treat is disclosed, ensuring high digestibility and avoiding the risk of sharp edges while retaining a chewy and flavorful profile.

### CROSS REFERENCE TO RELATED APPLICATIONS

The present application claims the benefit of co-pending U.S. application Ser. No. 17/918,305 filed Oct. 11, 2022; PCT Application No. PCT/US21/027931 filed Apr. 19, 2021; and Provisional application No. 63/013,533 filed Apr. 21, 2020, each entitled Rawhide-Free Highly Digestible Dog Chew, the disclosures of which are incorporated by reference in their entirety.

### FIELD OF THE INVENTION

The field of the present invention generally relates to pet treats and in particular to dog chews.

### BACKGROUND OF THE INVENTION

Dog chews are a very popular product category, built around the idea that chewing behaviors are an effective and easy method to clean dogs' teeth-resulting in better oral hygiene and improved breath. Furthermore, for many dogs this positive time occupier fulfills their natural chewing instinct reducing or eliminating chewing on other household objects (which could be dangerous to the dog or at least destructive to the owner's property). Finally, pet owners also may use chews as a form of reward for their pet (as a substitute for a dog treat). To ensure suitability for all of the typical use cases above two design factors stand out: palatability and hardness. Palatability of the dog chew is important to encourage dogs to start chewing and remain engaged in chewing. Hardness of the dog chew is important to ensure the chews last for a longer period of time and provide dental benefits as the chew scrapes against the teeth and gums. Therefore, an ideal dog chew will be inherently harder than a dog treat, but no less tasty.

A review of existing products in the dog chew category reveals a range of product types made from a variety of ingredients. First, the largest category of dog chews is whole-rawhide products—these products are made from the line split of animal skins (beef hide, pork hide, bison hide, etc.). Second, are dog chews made from reconstituted rawhide products which are often labeled on packaging as gelatin (per AFCCO's direction) or called collagen in marketing materials. Third, pet owners also often provide dogs with synthetic chews to provide the same time occupying and dental benefits as rawhide-based products. Lastly chews made from vegetables and gums provide another segment of items that are utilized as a dog chew. While a large assortment of products exists in the marketplace today, they all have inherent flaws that can be improved upon.

A first category of existing dog chews is rawhide—currently the most common chew on the market. However, despite significant growth in dog ownership and subsequent growth in the dog treat and chew categories, (30%+since 2003), rawhide retail purchases have remained relatively flat since 2003 (indicating a significant loss in market share). One reason this segment of chews has remained stagnant is many people are concerned with the manufacturing methodology and lack of regulations on the production of rawhide. Because nutritional claims are not made on the final rawhide product, consumer labeling disclosure is not legally required. It is also quite worrisome that as rawhide is a by-product of the leather and tannery industry, there is typically high exposure to chemicals, antibiotics and other potentially harmful additives, but none of these are required by law to be disclosed. Even during manufacturing, hides are split (separated) using a combination of mechanical and chemical steps.

In a frightening example, in 2017 a national recall was instituted from the largest rawhide factories in South, Central and North America. It was discovered that a quaternary ammonium compound mixture had been used as a processing aid in the manufacturing of the chews—this cleaning agent is not an approved or safe ingredient for pets, but without any oversight around final labelling, it took tragedy to bring attention to the risks.

In addition to manufacturing/chemical exposure concerns of rawhide, this material digests extremely slow, if at all. Pieces of rawhide, which naturally breakdown very slowly within a pet's gastrointestinal tract, have been known to cause severe medical issues when a blockage occurs. In vitro digestibility studies have further proven the above consumer concerns to be valid. In addition to its indigestibility, partially chewed pieces of hide often have sharp edges which can cause internal punctures or cuts for the pet.

Finally, rawhide provides almost no nutritional value for the pet. As such, many types of rawhide are often infused with secondary nutrients like vitamin E. These additives contribute to production cost and can prove ineffective anyway (due to uneven application of the nutrients as well as evaporation during the drying process). In terms of palatability, rawhide is also inherently flavorless and often requires palatants to be added to the material to get a dog interested to chew the product.

A second category of existing dog chews are those made from reconstituted rawhide-still inherently the same material; however, the rawhide has been processed to the extent that manufacturers are comfortable calling them collagen (notably, they are allowed by AFFCO industry guidelines to label this product as gelatin, obscuring the origin of its raw material in unregulated rawhide). Certain chews on the market today imply they are rawhide free with their product names like Nothin to Hide™ or NO Hide® but they cannot state they are rawhide free on their packaging. The reason the claim cannot be made on the packaging is these products are made by grinding up portions of animal skin (rawhide) and labeling it as gelatin in their ingredient statement. Some of these brands are also stating their products are made of collagen in off pack promotional materials. They cannot use collagen as an ingredient on their packaging label because collagen is not an approved ingredient through AFFCO (governing agency for pet food labeling). They do not label the animal skin as rawhide or beef hide on the packaging because of the negative consumer perception of the material. There are no genetic tests that can indicate what part of an animal the gelatin came from (only what species). Digestibility testing shows these products digest almost identically to ground up rawhide products commonly referred to as munchy rawhide which does digest faster than whole rawhide products. Even still, in vitro testing has shown that less than 90% of the material is digested within 18 hours after consumption, leaving a substantial potential for blockages to occur. The fact these products are made from rawhide was further validated by an in-depth study published by the Truth About Pet Food on Jul. 27, 2017. Like rawhide, many of these products are dipped in chicken to overcome the flavor limitations of inner material. Rawhide should be defined as animal skin, and therefore Rawhide-Free should be defined as not including any animal skin.

A third category of existing chews are made from synthetic materials such as plastic, nylon or rubber. These products often provide a long-lasting chew for dogs, but they are both completely indigestible and provide zero nutritional value. These synthetic chews also represent a significant health risk for dogs when—as easily happens—they break a portion of the chew off and swallow it. Finally, here too, palatability concerns arise as synthetic-based chews have no natural flavors of interest to a dog.

A fourth category of existing chews are vegetable-based. Long lasting vegetable-based chews are often made from base materials such as wheat, wheat glutens, soy, soy protein isolate, corn and corn starch which give the products a pliable texture suited to a dog chew. Many vegetable-based chews also combine the plant-based materials with gums to give the products the desired pliable texture. There are issues with each of the vegetable-based chews and vegetable-and-gum chews.

A first concern is potential for allergic reactions to the vegetable-based chews using wheat, corn and soy ingredients. While these three ingredients are the most common ingredients used to create vegetable-based chews, they are also often cited as the three most common food-based allergens for dogs. Pet owners have now become so widely aware of their pets' reactions to vegetable allergens, that nearly half of all pet foods sold in the U.S. are formulated to be free of corn, wheat and soy.

A second concern is the potential for intestinal blockage with vegetable-and-gum chews. Gum is inherently indigestible and as such it greatly reduces digestibility relative to what might be expected from their vegetable ingredients, which can still cause blockages.

Finally, both vegetable-based chews and vegetable-and-gum chews have palatability issues. As such palatability enhancers and/or secondary proteins sources are often added to the products to entice consumption. One product Smart Bones®, addresses this issued by including a patented feature of inserting meat in the middle of the chews.

Overall, the U.S. dog chew category (Natural Parts, Long Lasting Chews, Synthetic Chews) is currently valued at approximately $1.5 billion of sales across all brick and mortar retail channels of trade. Despite the size and importance of the category the largest segment rawhide hasn't shown significant growth. This lack of growth can be attributed to the inherent product limitations and consumer concerns within the categories, specifically digestibility of these products. Problems with the products currently on the market have made consumers widely aware of the category flaws. National attention was given to the product recalls on Greenies (the most popular vegetable-and-gum chew) due to choking and bowel obstruction. Many pet owners now express concerns about both digestibility and manufacturing process/chemical contaminants. These consumer concerns (which are based in genuine fact) have created a clear need for innovation within the category to develop a hide-free, allergen-free, gum-free, highly digestible, palatable dog chew that still maintains the required hardness for a long-lasting chew.

### SUMMARY OF THE INVENTION

Each of the existing chew types have inherent flaws with the base material they are made from. Rawhide is digested slowly, if at all. As such large pieces have been known to cause intestinal blockage. Synthetic chews are 100% indigestible for the dog and present a serious threat for choking or intestinal blockage. Collagen and reconstituted animal skin-based chews do digest faster than whole rawhide-based chews but still not fast enough to ensure no intestinal blockage is possible. Current vegetable-based chews utilize gum, an indigestible material, to achieve their desired texture as well as common allergens for dogs like corn, wheat, soy and glutens.

In an effort to move the product category forward and deliver a palatable dog chew, made from nutritious ingredients which are highly digestible and free of contaminants, we disclose a novel chew made from a combination of plant-based material, starches, animal proteins and a non-rawhide-based gelatin (preferably bone-based gelatin). In vitro testing of this novel chew has proven it will digest much faster than the products noted above.

We disclose an edible pet chew featuring an interior portion made of starches, grains, animal proteins and bone-based gelatin with a protein or flavor-based coating on the exterior of the chew. The combination of interior material and coating is at least 90% digested within 18 hours (as confirmed by in vitro procedures developed by Boisen and Eggum in 1991). To improve the digestibility of the dog chew, no gums are used in the production of the product. Additionally, the novel formula avoids the most common pet allergens (corn, wheat, soy and glutens) to reduce the chance for an allergic reaction. To overcome the inherent palatability concerns of the ingredients a protein and/or flavor-based coating is applied to the exterior.

As a first disclosure, a combination of (but not limited to) plant-based materials and bone-based gelatin are combined with various other ingredients to create a hardened or semi-hardened form. These forms will allow for various shapes and textures to be formed out of the materials through various methods of manufacturing. Those formed shapes are coated with various proteins or a combination of proteins and flavorings to improve palatability. The entire product is then dehydrated (fully or partially) or cooled. By removing moisture, applying pressure and/or cooling the material it will become hard enough to form a chew for dogs. Despite the hard texture of the product the product will be at least 90% digested by dogs within 18 hours of consumption removing the inherent blockage concerns found in other forms of dog chews.

As a second disclosure, in certain iterations the moist, semi-pliable or hardened material would be made into thin sheets using various manufacturing techniques. This sheeted material can then be made into a variety of shapes through hand or robotic tying, rolling or layering the material to change the thickness of the product. Those formed shapes are coated with various animal, fish or poultry proteins or a combination of those proteins, binding agents, water stabilizers or humectants and flavorings to improve palatability. The entire product is then dehydrated (fully or partially) or cooled to a point where it becomes sufficiently hard enough to form a chew for dogs.

As a third disclosure, in certain iterations the material can be forced through a single or multiple extrusion die heads to form a single shape or a shape with a variety of colors, flavors or textures in varying layers. Those formed shapes are coated with various proteins or a combination of proteins and flavorings to improve palatability. The entire product is then dehydrated (fully or partially) or cooled to a point where it becomes hard enough to form a chew for dogs.

As a third disclosure, in certain iterations these chews would be formed using compression molding. Those formed shapes are coated with various proteins or a combination of proteins and flavorings to improve palatability. The entire product is then dehydrated (fully or partially) or cooled to a point where it becomes hard enough to form a chew for dogs.

An ideal hide-free dog chew would balance highly digestibility (demonstrated through in vitro testing such as the Boisen & Eggum protocols cited above) and enjoyable texture and flavor (for dogs), with ease of manufacture. To ensure safety and digestibility it must be a pet chew that didn't contain any animal skin (whole, ground or otherwise), and for marketability it must fit what pet parents want (no corn, no wheat, no soy, no pea, no syrups, no gums).

As a fourth disclosure Table 1 sets forth the ingredient functions for certain preferred ingredients of the disclosed composition for a hide-free dog chew.

TABLE 1

| Macro Ingredient | Selected Ingredients |
|---|---|
| Starch | Rice, Rice Flour, Brown Rice, Brown |
| | Rice Flour, Potato & Potato Starch |
| Animal Protein/Flavor | Chicken, Beef, Salmon, Duck, Lamb, |
| | Bison, Rabbit & Peanut Flour |
| Binding Agent | Bone-based Gelatin |
| Humectant | Vegetable Glycerin, Sorbitol & Dextrose |
| Preservatives | Salt & Vitamin E |

First, a starch must be selected that is suitable for manufacturing and not among those starches commonly avoided by modern pet parents (such as avoiding corn, wheat, soy and pea).

In one embodiment of the invention, the starches are a blend of rice flour and potato flour, though the starches could include rice, rice flour, brown rice, brown rice flour, potato and potato starch.

In a further embodiment of the invention, an animal protein and or flavor must be selected that is suitable for manufacturing and provides an enjoyable texture and flavor to dogs and avoids syrups. In one embodiment of the invention, the animal protein/flavor is selected from the group consisting of chicken, beef, salmon, duck, lamb, bison, rabbit & peanut flour.

In one embodiment of the invention, a binding agent must be selected that is suitable for manufacturing and avoids gums.

In a further embodiment of the invention, the binding agent is bone-based gelatin.

In one embodiment of the invention, one or more humectants must be selected.

In a further embodiment of the invention, the humectant is selected from the group consisting of Vegetable Glycerin, Sorbitol and Dextrose.

In one embodiment of the invention, one or more preservatives must be selected to maintain freshness and product quality.

In a further embodiment of the invention, the preservative must be selected from the group consisting of Salt and Vitamin E.

Table 2 shows the ranges of possible macro ingredients (% by weight) of a hide-free dog chew, providing both minimal and preferred ranges for each macro.

TABLE 2

| | Minimal | Preferred |
|---|---|---|
| Macro Ingredient | Range | Range |
| (example) | (% by wt) | (% by wt) |
| Starch (Rice, Rice Flour, Brown Rice, | 40% to 60% | 42% to 48% |
| Brown Rice Flour, Potato & Potato | | |
| Starch) | | |
| Animal Protein/Flavor (Chicken, Beef, | 8% to 30% | 22% to 29% |
| Salmon, Duck, Lamb, Bison, Rabbit & | | |
| Peanut Flour) | | |
| Binding Agent (Bone-based Gelatin) | 15% to 20% | 15% to 18% |
| Humectant (Vegetable Glycerin, | 10% to 16% | 10.5% to 12.5% |
| Sorbitol & Dextrose) | | |
| Preservatives (Salt & Vitamin E) | 0.5% to 4% | 0.5% to 2.0% |

In a further embodiment of the hide-free dog chew, the starch comprises rice flour and potato starch; the animal protein/flavor is selected from the group consisting of chicken, beef and peanut flour; the binding agent is bone-based gelatin; the humectant comprises vegetable glycerin and sorbitol; and, the preservative comprises salt and vitamin E.

To produce a hide-free dog chew from these ingredients, an intermediate mixture comprising the starch, the binding agent, the humectant and the preservative is prepared. The intermediate mixture may be formed into a dog chew by injection molding, compression molding or by dehydrating on large trays.

In a further embodiment of the hide-free dog chew, the intermediate mixture is processed into a final form by compression molding, wherein the intermediate mixture is pre-heated and placed onto an open heated mold cavity, and wherein the open heated mold cavity is closed and pressurized. The final form is coated with the animal protein/flavor then hardened by dehydration, baking or cooling.

In a further embodiment of the hide-free dog chew, the intermediate mixture is extruded using multiple extrusion die heads forming a variety of intermediate forms which may be coated in one or more animal protein/flavor ingredients then combined resulting in a final form with a variety of colors, flavors and textures in layers. The final form may also be coated with the animal protein/flavor then hardened by dehydration, baking or cooling.

In a further embodiment of the hide-free dog chew, the intermediate mixture is formed into a thin sheet by extrusion. The thin sheet is processed into a final form by cutting, hand tying, robotic tying, rolling or layering. The final form is then coated with the animal protein/flavor and hardened by dehydration, baking or cooling.

### BRIEF DESCRIPTION OF THE DRAWINGS

Preferred and alternative examples of the present invention are described in detail below with reference to the following Figure drawings:

FIG. 1 is a photograph that shows an end-view of one embodiment of an uncoated, sheeted, rolled, highly digestible, rawhide-free dog chew (either as an intermediate form yet to be coated or as a final form of an uncoated dog chew);

FIG. 2 is a photograph that shows a perspective-view of one embodiment of an uncoated, sheeted, rolled, highly digestible, rawhide-free dog chew (either as an intermediate form yet to be coated or as a final form of an uncoated dog chew);

FIG. 3 is a photograph that shows a side-view of one embodiment of a coated, sheeted, rolled, highly digestible, rawhide-free dog chew (as a final form of a coated dog chew);

FIG. 4 is a photograph that shows an end-view of one embodiment of a coated, sheeted, rolled, highly digestible, rawhide-free dog chew (as a final form of a coated dog chew);

FIG. 5 is a photograph that shows a side-view of one embodiment of an uncoated, sheeted, cut and tied, highly digestible, rawhide-free dog chew (either as an intermediate form yet to be coated or as a final form of an uncoated dog chew);

FIG. 6 is a photograph that shows a side-view of one embodiment of a coated, sheeted, cut and tied, highly digestible, rawhide-free dog chew (as a final form of an uncoated dog chew);

### DETAILED DESCRIPTION

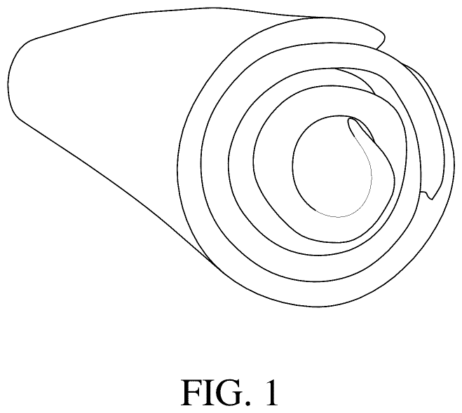

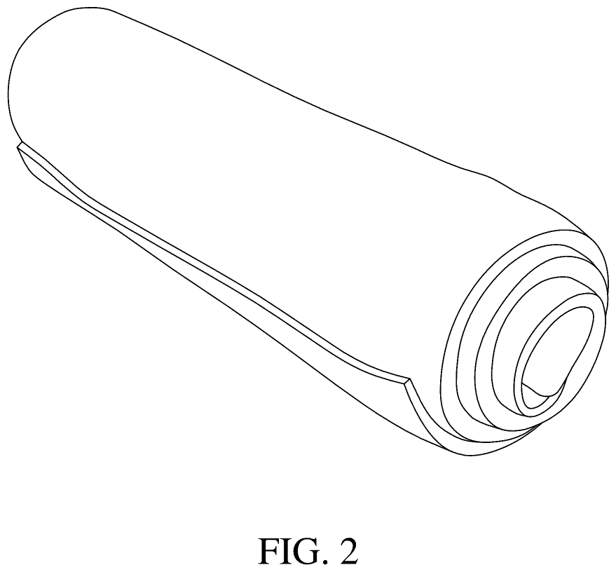

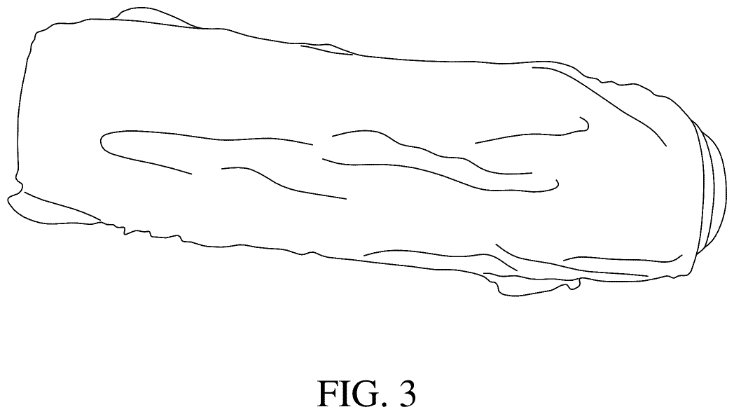

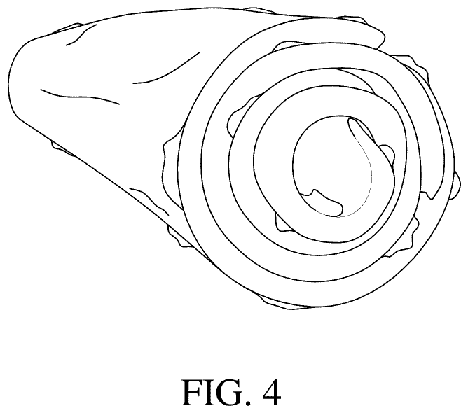

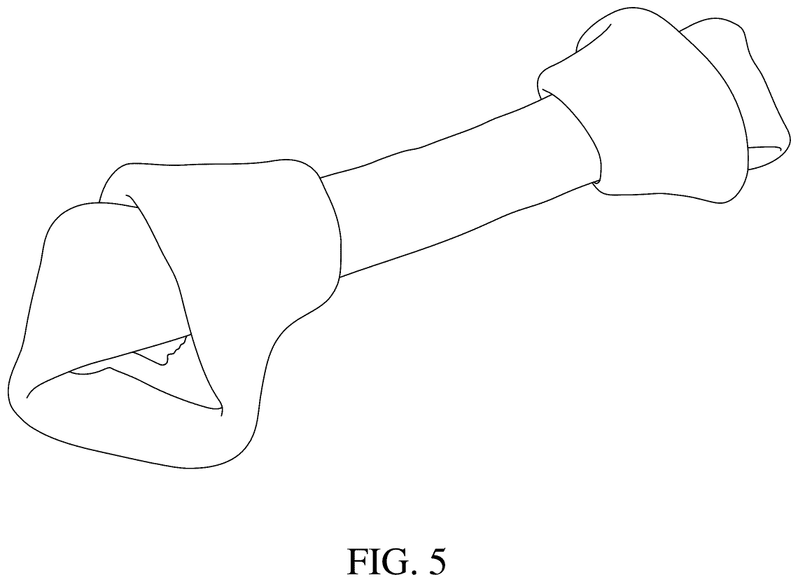

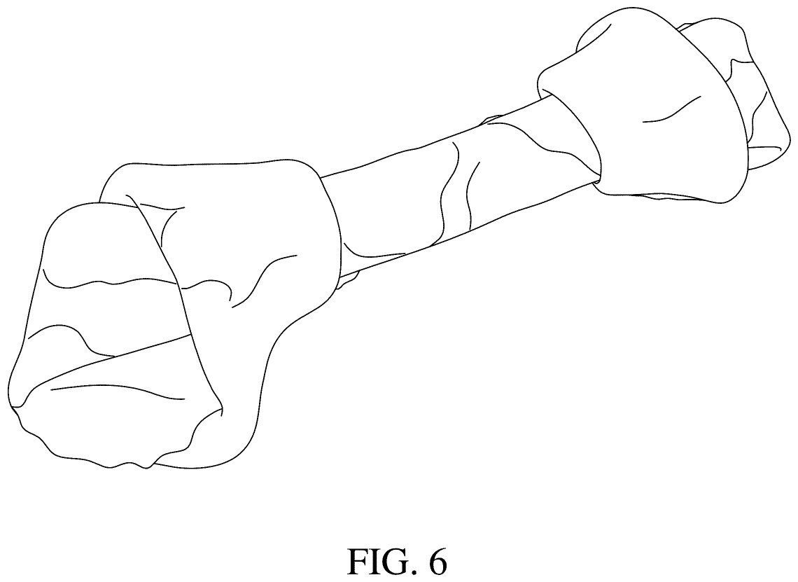

The invention shown in FIG. 1, FIG. 2, FIG. 3, FIG. 4, FIG. 5 and FIG. 6 is a rawhide-free (including reconstituted rawhides), gum-free, allergen-free highly digestible vegetable and bone-gelatin based dog chew.

In a first preferred embodiment, a combination of plant-based materials not including corn, wheat, soy or glutens are combined with binding agents like bone-based gelatins, humectants and preservatives. In addition, preservatives or water stabilizers, like vegetable glycerin, may be added to the formulation for shelf stability. Other binding agents and preservatives may be used in addition to those listed above. A flavoring may also be added to the material to increase palatability. As shown in FIG. 3, FIG. 4 and FIG. 6, a coating of flavored material may be added to the plant-based material (1) in a secondary process to improve the palatability of the product. This coating can be poultry, meat or fish or a combination of ingredients like meats, flavorings, preservatives and other binding agents to make the material pliable enough so that the plant-based material (1) can be coated. These two materials are then hardened through baking, dehydration or other manufacturing techniques to form a texture suitable for dog chews.

In certain embodiments the plant-based materials not including corn, wheat, soy or glutens are combined with binding agents like bone-based gelatins, humectants and preservatives and then formed into thin sheets. These thin sheets can be manufactured through extrusion, compression molding, rolling or dehydrating the material on large trays until it reaches a semi-pliable or non-pliable state. These sheets can then be rolled or layered into the shape of a cylinder (roll) as shown in FIG. 1, FIG. 2, FIG. 3 and FIG. 4 or cut into various shapes. Thin strips may also be cut, tied and or layered into shapes, such as a dog bone as shown in FIG. 5 and FIG. 6. A coating of flavored material may be added to the sheeted plant-based material (1) in a secondary process to improve the palatability of the product. This coating can be poultry, meat or fish or a combination of ingredients like meats, flavorings, preservatives and other binding agents to make the material pliable enough so that the plant-based material (1) can be coated. These two materials are then hardened through baking, dehydration or other manufacturing techniques to form a texture suitable for dog chews as shown in FIG. 3, FIG. 4 and FIG. 6.

In certain embodiments the plant-based materials not including corn, wheat, soy or glutens are combined with binding agents like bone-based gelatins, humectants and preservatives. The ingredients are heated and then extruded through a single or multiple die heads to form a shape. A coating of flavored material may be added to the sheeted plant-based material (1) in a secondary process. This coating can be poultry, meat or fish or a combination of ingredients like meats, flavorings, preservatives and other binding agents to make the material pliable enough so that the plant-based material (1) can be coated. These two materials are then hardened through baking, dehydration or other manufacturing techniques to create a texture suitable for dog chews.

In certain embodiments the plant-based materials not including corn, wheat, soy or glutens are combined with binding agents like bone-based gelatins, humectants and preservatives and are then formed using compression molding. In this iteration the plant-based material (1) is pre-heated and then placed onto an open heated mold cavity. The mold is then closed, and pressure is applied to force the material into contact with all mold areas. This heat and pressure are maintained until the plant-based material (1) has been cured. Once this material is cured it is removed from the mold it is coated in a secondary process through dipping or enrobing the product with a coating made from poultry, meat or fish or a combination of ingredients like meats, flavorings, preservatives and other binding agents to make the material pliable enough so that the plant-based material can be coated. These two materials are then hardened through baking, dehydration or other manufacturing techniques to make the material hard enough to be sufficient to withstand dog's chewing.

In certain embodiments the plant-based materials not including corn, wheat, soy or glutens are combined with binding agents like bone-based gelatins, humectants and preservatives and are then formed using injection molding.

In certain embodiments a hole can be created in the center of the dog chew. This hole can then be filled with a flavored material via a secondary application. In a further embodiment still, after the secondary application of filling the central hole with a flavored material, the dog chew can still be coated as above (with protein and/or flavoring).

The embodiments of the invention in which an exclusive property or privilege is claimed are defined as follows:

1. A hide-free dog chew comprising a starch, a binding agent, a humectant, a preservative and an animal protein/flavor.

2. The hide-free dog chew of claim 1, wherein the dog chew excludes any rawhide, reconstituted rawhide or gum-based ingredients.

3. The hide-free dog chew of claim 2, wherein the starch is selected from the group consisting of rice, rice flour, brown rice, brown rice flour, potato and potato starch; the animal protein/flavor is selected from the group consisting of chicken, beef, salmon, bison, rabbit, duck and peanut flour; the humectant comprises vegetable glycerin and sorbitol; and, the preservative comprises salt and vitamin E.

4. The hide-free dog chew of claim 2, wherein the starch is rice flour and potato starch; wherein the animal protein/flavor is selected from the group consisting of chicken, beef and peanut flour; wherein the binding agent is bone-based gelatin; and, wherein the humectant consists of vegetable glycerin and sorbitol.

5. The hide-free dog chew of claim 2, wherein the starch is in a range of 40% to 60% by weight; wherein the animal protein/flavor is in a range of 8% to 30% by weight; wherein the binding agent is in a range of 15% to 20% by weight; and, wherein the humectant is in a range of 10% to 16% by weight.

6. The hide-free dog chew of claim 2, wherein the starch is in a range of 42% to 48% by weight; wherein the animal protein/flavor is in a range of 22% to 29% by weight; wherein the binding agent is in a range of 15% to 18% by weight; and, wherein the humectant is in a range of 10.5% to 12.5% by weight.

7. The hide-free dog chew of claim 3, wherein the starch is in a range of 40% to 60% by weight; wherein the animal protein/flavor is in a range of 8% to 30% by weight; wherein the binding agent is in a range of 15% to 20% by weight; and, wherein the humectant is in a range of 10% to 16% by weight.

8. The hide-free dog chew of claim 3, wherein the starch is in a range of 42% to 48% by weight; wherein the animal protein/flavor is in a range of 22% to 29% by weight; wherein the binding agent is in a range of 15% to 18% by weight; and, wherein the humectant is in a range of 10.5% to 12.5% by weight.

9. The hide-free dog chew of claim 5, wherein an intermediate mixture comprising the starch, the binding agent, the humectant and the preservative is prepared.

10. The hide-free dog chew of claim 9, wherein the intermediate mixture is formed into a dog chew by injection molding.

11. The hide-free dog chew of claim 9, wherein the intermediate mixture is dehydrated on large trays to form a thin sheet.

12. The hide-free dog chew of claim 9, wherein the intermediate mixture is formed into a thin sheet by compression molding.

13. The hide-free dog chew of claim 9, wherein the intermediate mixture is processed into a final form by compression molding, wherein an intermediate mixture is pre-heated and placed onto an open heated mold cavity, and wherein the open heated mold cavity is closed and pressurized.

14. The hide-free dog chew of claim 13, wherein the final form is coated with the animal protein/flavor then hardened by dehydration, baking or cooling.

15. The hide-free dog chew of claim 9, wherein the intermediate mixture is extruded into a final form.

16. The hide-free dog chew of claim 15, wherein the final form is coated with the animal protein/flavor then hardened by dehydration, baking or cooling.

17. The hide-free dog chew of claim 9, wherein the intermediate mixture is extruded using multiple extrusion die heads forming a variety of intermediate forms, and wherein the variety of intermediate forms are combined resulting in a final form.

18. The hide-free dog chew of claim 9, wherein the intermediate mixture is formed into a thin sheet by extrusion.

19. The hide-free dog chew of claim 18, wherein the thin sheet is processed into a final form by cutting, hand tying, robotic tying, rolling or layering.

20. The hide-free dog chow of claim 19, wherein the final form is coated with the animal protein/flavor then hardened by dehydration, baking or cooling.
